(19) United States
(12) Patent Application Publication
(10) Pub. No.: US 2005/0111660 A1
(43) Pub. Date: May 26, 2005

(54) Transmitting apparatus and method, receiving apparatus and method, and transmitting and receiving system and method

(75) Inventor: Takashi Hosoda, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/942,775

(22) Filed: Sep. 17, 2004

(30) Foreign Application Priority Data
Sep. 19, 2003 (JP) P2003-329068

(51) Int. Cl. H04L 9/00

(52) U.S. Cl. 380/44

(57) ABSTRACT

A PC is authenticated by a server (SEQ100). When a monitoring start request is issued (SEQ101), an in-house security unit generates a one-time key (SEQ106). The one-time key and information ex. a port number with which the PC is connected to the in-house security unit is passed to the PC through the server (SEQ110). The PC and the in-house security unit are connected in PtoP (SEQ111). The in-house security unit encrypts a picture photographed by the surveillance camera with the one-time key and then streamingly transmits the encrypted picture data to the PC (SEQ114). The PC decrypts the received stream data with the pre-received one-time key, restores the original picture, and displays the restored original picture on a display portion. When a monitoring stop request is sent from the PC to the in-house security unit (SEQ112, 123), the in-house security unit deletes the one-time key (SEQ124).

### BACKGROUND OF THE INVENTION

1. Field of the Invention

The present invention relates to transmitting apparatus and method, receiving apparatus and method, and transmitting and receiving system and method that are suitable for use with a security system that transmits a picture photographed by a surveillance camera disposed in a private house through a network.

2. Description of the Related Art

So far, a security system of which a security sensor and a surveillance camera are disposed in a private house and a sensor output and a picture photographed by the surveillance camera are transmitted from the private house to a security server has been used so as to prevent the house from crimes.

For example, a terminal unit is disposed in each house. One or more surveillance cameras and sensors are disposed and connected to the terminal unit. The terminal unit is connected to a security server through a network such as the Internet. Outputs of the surveillance camera and the sensor are sent to the terminal unit and then to the security server through the network. The security server watches over an abnormal situation such as an intruder in accordance with surveillance information transmitted from each house. When the security server detects an abnormal situation, the security server informs the user or a security company of the abnormal situation.

In recent years, a such security system of which a picture photographed by a surveillance camera disposed in a user's house is transmitted over the Internet and the interior of the house is monitored with the photographed picture on an information unit such as a personal computer connected to the Internet has been proposed.

In such a system, since a picture photographed in the house is transmitted through the Internet, from a view point of privacy, it is essential that photographed picture data that is transmitted should be encrypted. The security server distributes a decryption key for the encrypted photographed picture to the user. When the user receives the picture photographed by the surveillance camera with the information unit, it will decrypt the encrypted picture data with the provided key, restore the original photographed picture data, display the restored picture data on a display unit of the information unit, and monitor the situation in the house.

As a method for safely distributing the key to the user, a dongle is used. For example, the dongle has an internal memory. When the dongle is used, it is connected to an input/output (I/O) port of the information unit. In the memory of the dongle, the decryption key is stored. The hardware or software of the information unit side decrypts encrypted data with the decryption key stored in the memory. An example of the dongle that uses a universal serial bus (USB) as the I/O interface is described in Non-patent Related Art Reference 1.

[Non-Patent Related Art Reference]

“eToken Product Information”, Aladdin Japan Co., Ltd. [online] Jul. 10, 2003, Aladdin Japan Co., Ltd, [Searched on Sep. 12, 2003], Internet <URL: http://www.aladdin.co.jp/etoken/index_pro_r2.html>

Next, a method for distributing an encryption key using a dongle will be described. For example, when a terminal unit is produced, an encryption key is stored in a memory or the like of the terminal unit. In addition, a decryption key in accordance with the encryption key is stored in the dongle and is distributed to the user.

Next, the case that a common key of an encryption key and a decryption key is used will be described. When a user A who has a dongle that stores the common key of the encryption key and the decryption key can capture photographed picture data that has been encrypted with the common encryption key stored in a dongle of a user B and that has been transmitted over the Internet, the user A can decrypt the captured encrypted data with the common decryption key stored in the dongle and reproduce the original photographed picture. Thus, the encryption key and the decryption key should be unique to each terminal unit.

In the case that the encryption key and the decryption key that are unique for each terminal unit are used, when the user remotely monitors the interior of the house with a picture photographed by the surveillance camera disposed in the house using an information unit (personal computer), the terminal unit side encrypts photographed picture data with the encryption key unique to the terminal unit and transmits the encrypted photographed picture data. Software of the personal computer side obtains the decryption key in accordance with the encryption key unique to the terminal unit from the dongle. The software decrypts the received data with the obtained decryption key and restores the original photographed picture data.

In such a system, since the encryption key and the decryption key that are unique to each terminal unit should be stored, they will raise the cost of the system. In addition, the use of the dongle will also raise the cost of the system.

When the user lost the dongle, its substitute should be issued. When the dongle is issued again, it is necessary to determine whether the user has been authorized. Thereafter, the decryption key will be stored in the substitute dongle. The substitute dongle will be sent to the user. In the method of which the decryption key is distributed using a dongle, if the user lost the dongle, a cost for the substitute dongle will be required.

### OBJECTS AND SUMMARY OF THE INVENTION

Therefore, an object of the present invention is to provide transmitting apparatus and method, receiving apparatus and method, and transmitting and receiving apparatus and method that allow a unique key with which a photographed picture is encrypted and decrypted to be safely distributed to the user at low cost through a network.

A first aspect of the present invention is a transmitting apparatus for transmitting stream data through a network, comprising generating means for generating a key in accordance with a transmission request for stream data that a reception side has made; key transmitting means for transmitting the generated key to the reception side through an authenticating server; and stream data encrypting and transmitting means for encrypting the stream data with the key and transmitting the encrypted data to the reception side after the key has been transmitted to the reception side.

A second aspect of the present invention is a receiving apparatus for receiving stream data transmitted through a network, comprising key receiving means for receiving a key generated on a transmission side in accordance with a transmission request for stream data transmitted to the transmission side and transmitted through an authenticating server; stream data receiving means for receiving the stream data that has been encrypted with the key and that has been transmitted from the transmission side after the key has been received; and stream data decrypting means for decrypting the received stream data with the key that has been received.

A third aspect of the present invention is a transmitting and receiving system for transmitting stream data through a network and receiving the transmitting stream data, comprising a transmitting apparatus for transmitting stream data; a receiving apparatus for receiving the stream data from the transmitting apparatus; and an authenticating server for authenticating the receiving apparatus, wherein the transmitting apparatus is configured to generate a key in accordance with a transmission request for stream data that the receiving apparatus has made, transmit the generated key to the receiving apparatus through an authenticating server, and encrypt the stream data with the key and transmit the encrypted data to the receiving apparatus after the key has been transmitted to the receiving apparatus, and wherein the receiving apparatus is configured to decrypt the stream data with the key that has been received from the transmitting apparatus.

A fourth aspect of the present invention is a transmitting and receiving method for transmitting stream data through a network and for receiving the transmitted stream data, comprising the steps of transmitting a key generated on a transmission side to a reception side through an authenticating server in advance; encrypting stream data with the key on the reception side; and transmitting the encrypted stream data to a reception side; and decrypting the encrypted stream data with the key on the reception side.

According to the present invention, the transmission side generates a key whenever the reception side requests the transmission side to transmit a key. Then, the transmission side transmits the generated key to the reception side. Thereafter, the transmission side encrypts stream data with the key and transmits the encrypted data to the reception side. The reception side decrypts the stream data with the key transmitted from the transmission side. Thus, data can be encrypted and decrypted with a key that is unique whenever the data is transmitted.

Data is encrypted with a key that is unique whenever the data is transmitted. In addition, since the key is deleted when the transmission of stream data is stopped. Thus, even if a key was leaked out, newly captured stream data cannot be decrypted with the former leaked-out key, namely by another person.

Since a key is transmitted as data to the reception side through a network, the distribution and redistribution of the key are almost costless.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawing, wherein like reference numerals denote like elements, in which:

FIG. 1 is a schematic diagram showing a security system according to the present invention;

FIG. 2 is a block diagram detailing the security system according to the present invention;

FIG. 3 is a sequence chart showing an example of a procedure for monitoring the interior of a house with picture data photographed by a surveillance camera according to an embodiment of the present invention;

FIG. 4 is a schematic diagram showing an example of the structure of a packet that contains photographed picture data; and

FIG. 5 is a schematic diagram showing an example of a display screen on which the interior of the house can be monitored with photographed picture data.

### DETAILED DESCRIPTION OF THE PREFERRED EMBODIMENT

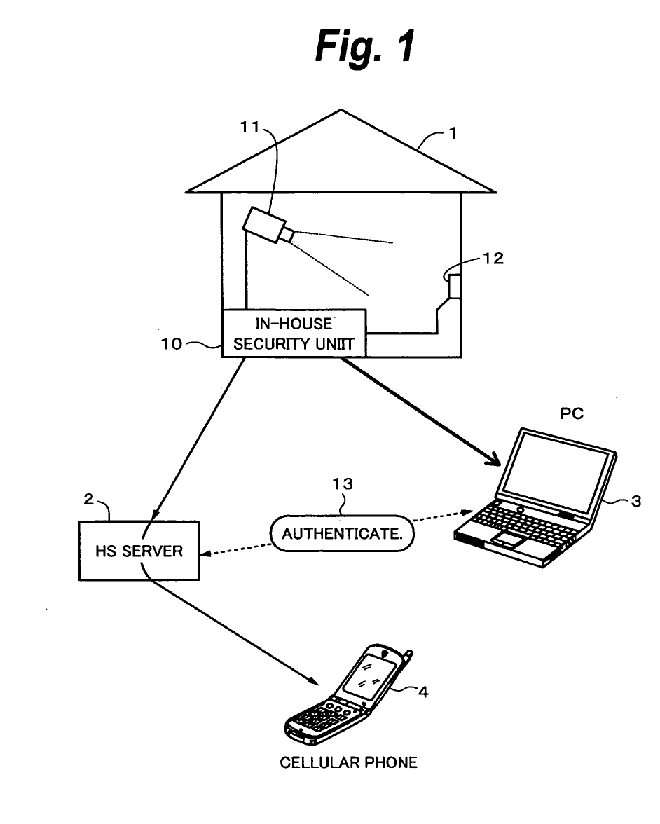

Next, with reference to the accompanying drawings, an embodiment of the present invention will be described. FIG. 1 is a schematic diagram outlining a security system according to the present invention. An in-house security unit 10 is disposed in a house 1. In addition, a surveillance camera 11 and a sensor 12 are disposed at one or more positions of the house 1. The surveillance camera 11 and the sensor 12 are connected to the in-house security unit 10. A picture photographed by the surveillance camera 11 and a signal detected by the sensor 12 are transmitted to the in-house security unit 10. The in-house security unit 10 controls the operation of the surveillance camera 11.

The in-house security unit 10 is connected to a home security (HS) server 2 through a network such as the Internet. The picture photographed by the surveillance camera 11 and the signal detected by the sensor 12 are transmitted from the in-house security unit 10 to the HS server 2. The HS server 2 also has a database for user information in which the designated address of the user, the address of the house 1 of the user, and information about the sensor 12 and the surveillance camera 11 disposed in the house 1.

When an abnormal situation such as a trespass takes place in the house 1 and the abnormal situation is detected by the sensor 12, the surveillance camera 11 is automatically activated. The surveillance camera 11 photographs a still picture and a moving picture of the interior of the house 1. The photographed picture data is sent to the in-house security unit 10 and then transmitted to the HS server 2 through the network.

When the in-house security unit 10 informs the HS server 10 of an abnormal situation, the HS server references the database and searches for the designated address of the user and informs a terminal unit 4 registered as the user's designated address that the abnormal situation has taken place. When the terminal unit 4 of the designated address is a cellular phone terminal unit that can receive and display a picture, a part of a still picture or a moving picture photographed by the surveillance camera 11 can be transmitted to the cellular phone terminal unit.

A PC 3 is an information unit such as a personal computer. The PC 3 is connected to the HS server 2 through a network (not shown). In addition, the PC 3 is connected to the in-house security unit 10 through the network. The PC 3 and the HS server 2 are authenticated with for example a user ID and a password. When they have been successfully authenticated, the information unit 3 and the in-house security unit 10 are connected. As a result, the information unit 3 can monitor the interior of the house with a picture photographed by the surveillance camera 11.

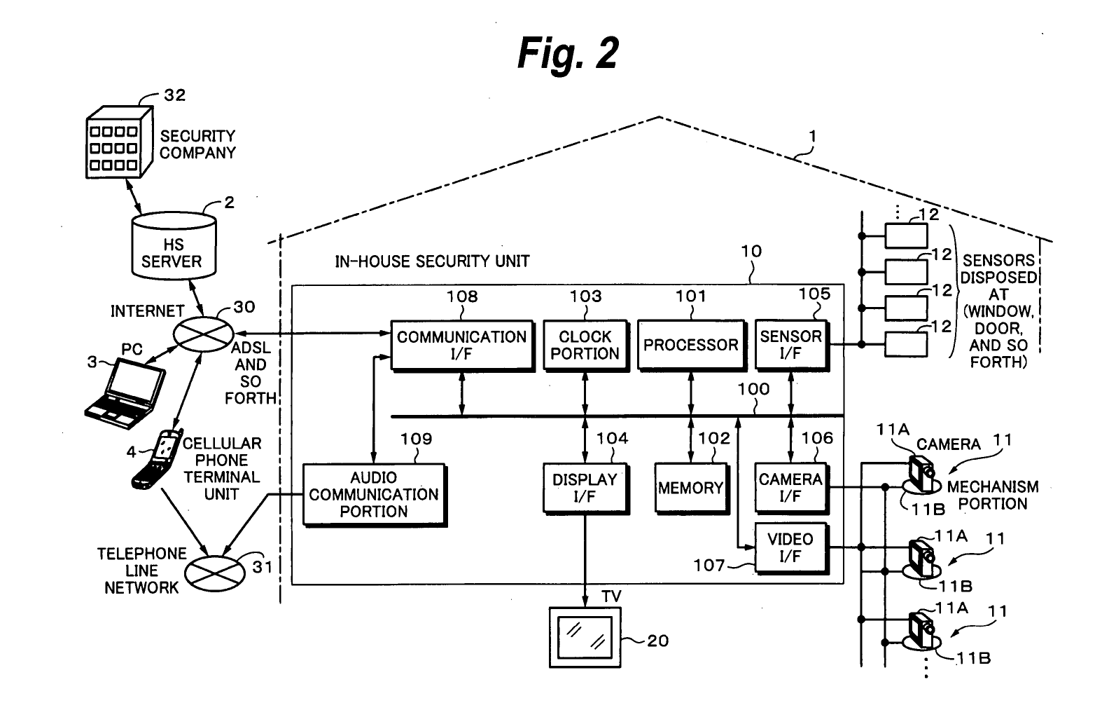

FIG. 2 shows the foregoing security system in detail. The in-house security unit 10 has a bus 100. A processor 101, a memory 102, a clock portion 103, a display interface (I/F) 104, a sensor I/F 105, a camera I/F 106, a video I/F 107, and a communication I/F 108 are connected to the bus 100. The memory 102, which is omitted in FIG. 2, is composed of a random access memory (RAM) and a read only memory (ROM). The processor 101 operates the RAM as a work memory in accordance with a program pre-stored in the ROM. The processor 101 controls the entire in-house security unit 10.

The clock portion 103 generates a clock. Time information such as current time can be obtained in accordance with the clock. The display I/F 104 converts a display control signal generated by for example the processor 101 and supplied through the bus 100 into a signal that can be displayed by a television receiver 20 that is a monitor unit.

As mentioned above, sensors 12, 12, and so forth that detect abnormal situations are disposed in the house 1. The sensors 12, 12, and so forth are of a type detecting that a window or a door is open, a type detecting that a window is broken, and a type detecting a trespasser with a heat thereof using an infrared ray sensor. Outputs of the sensors 12, 12, and so forth are supplied to the sensor I/F 105 and converted into signals that can be used by the processor 101.

The cameras 11, 11, and so forth disposed in the house 1 are composed of a camera body portion 11A and a mechanism portion 11B each. The camera body portion 11A is mainly composed of an optical system that photographs a picture. The mechanism portion 11B controls the posture and motion of the camera body portion 11A.

The camera body portions 11A, 11A, and so forth can photograph a still picture and a moving picture in accordance with a control signal. The camera body portions 11A, 11A, and so forth are connected to the video I/F 107. Picture data photographed by the camera body portions 11A, 11A, and so forth are supplied to the processor 101 through the video I/F 107. In addition, a control signal that controls the camera body portions 11A, 11A, and so forth is exchanged between them and the video I/F 107. The camera body portion 11A can select a still picture or a moving picture to photograph and perform a necessary control such as a shutter in accordance with a control signal. The photographed picture data is processed in a predetermined manner by for example the processor 101. Thereafter, the processed picture data is temporarily stored in the memory 102.

On the other hand, the mechanism portions 11B, 11B, and so forth are connected to the camera I/F 106. The mechanism portions 11B, 11B, and so forth control the postures of the camera body portions 11A, 11A, and so forth in accordance with a control signal supplied from the camera I/F 106. For example, the horizontal and vertical angles of the camera body portion 11A are designated in accordance with a control signal so that the posture of the camera body portion 11A is controlled with a designated angle against the default position. According to this embodiment, the mechanism portions 11B, 11B, and so forth have a limited moving range each. For example, the mechanism portions 11B, 11B, and so forth can control the postures of the camera body portions 11A, 11A, and so forth in the horizontal direction by for example 120°.

The communication I/F 108 is connected to a network such as the Internet 30 with a predetermined communication line. The communication I/F 108 controls a communication through the network. Since picture data photographed by the surveillance cameras 11, 11, and so forth should be transmitted over the Internet 30, it is preferred that a communication line having a high communication rate such as an asymmetric digital subscriber line should be used.

An audio communication portion 109 is connected to the communication I/F 108. The audio communication portion 109 makes an audio communication through a telephone line network 31. Audio data synthesized by the processor 101 in accordance with a predetermined text is supplied to the audio communication portion 109 through the communication I/F 108. The audio communication portion 109 is informed of the telephone number of the remove party. The audio communication portion 109 calls the obtained telephone number and sends the supplied audio data as an audio signal to the telephone line network 31.

In the foregoing structure, when an abnormal situation such as a trespass has taken place in the house 1 and the sensor 12 has detected it, the surveillance camera 11 is automatically activated. The surveillance camera 11 photographs a still picture or a moving picture of the interior of the house 1. The surveillance camera 11 is automatically oriented to the sensor 12 that has detected an abnormal situation. The surveillance camera 11 automatically photographs a picture in the direction of the sensor 12. First, the surveillance camera 11 photographs a still picture. Thereafter, while panning in the movable range, the surveillance camera 11 photographs several still pictures. Then, while panning in the movable range, the surveillance camera 11 photographs a moving picture. Whenever the surveillance camera 11 photographs a picture, the surveillance camera 11 transmits the photographed picture data to the in-house security unit 10. Thereafter, the photographed picture is transmitted to the HS server 2 through the Internet 30.

When the in-house security unit 10 disposed in the house 1 informs the HS server 2 of an abnormal situation, the HS server 2 searches the database for the user's designated address and informs the terminal unit 4 registered as the user's designated address that the abnormal situation has taken place. In this case, text data is automatically generated in accordance with the abnormal situation and user information. The generated text data is synthesized and read out. When the designated terminal unit 4 can receive and display a picture (the terminal unit 4 is for example a cellular phone terminal that has a picture display function), a part of a still picture or a part of a moving picture photographed by the surveillance camera 11 may be transmitted to the terminal unit 4.

When the user has contracted with a security company 32 or the like, if necessary, the HS server 2 will also inform the security company 32 along with the user (terminal unit 4) that the abnormal situation has taken place.

With the information unit 3 for example a personal computer (PC) connected to the Internet 30, the user can monitor the interior of the house with a picture photographed by the surveillance camera 11. The information unit 3 is connected to the HS server 2 through the Internet 30. The information unit 3 and the HS server 2 are authenticated with for example a user ID and a password.

When the information unit 3 and the HS server 2 have been successfully authenticated, it opens a port of the in-house security unit 10 for the information unit 3. As a result, the information unit 3 and the in-house security unit 10 are connected through the network. As will be described later, the in-house security unit 10 generates an encryption/decryption key. The key is passed from the in-house security unit 10 to the information unit 3.

When the information unit 3 and the in-house security unit 10 are connected through the Internet 30 and a port of the in-house security unit 10 is opened to the information unit 3, the in-house security unit 10 controls the surveillance camera 11 in accordance with a user's operation of the information unit 3. The surveillance camera 11 photographs a picture. The photographed picture data is encrypted with a key generated by the in-house security unit 10. The encrypted picture data is transmitted to the information unit 3 through the network. The information unit 3 decrypts the received picture data with a key that has been received from the in-house security unit 10, restores the original picture data, and displays the restored picture data on the display portion.

Only when the sensors 12, 12, and so forth have not detected an abnormal situation, on the information unit 3, the user can monitor the interior of the house 1 with a picture photographed by the surveillance camera 11 disposed in the house 1. When the sensors 12, 12, and so forth have detected an abnormal situation, the information unit 3 prioritizes the foregoing process for the abnormal situation.

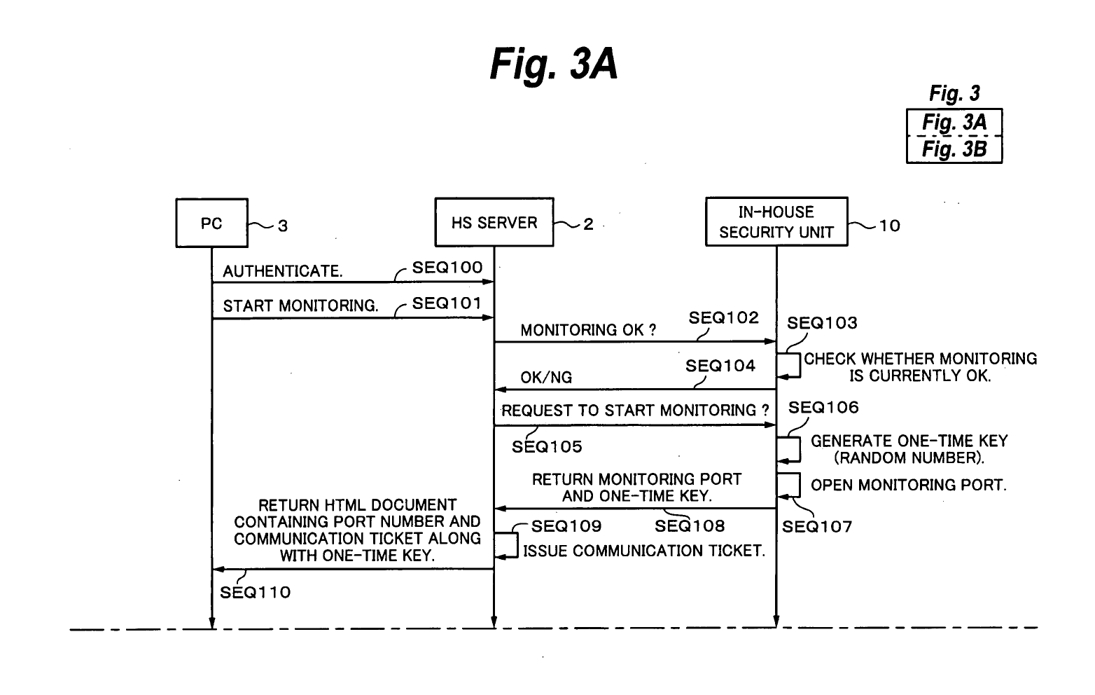

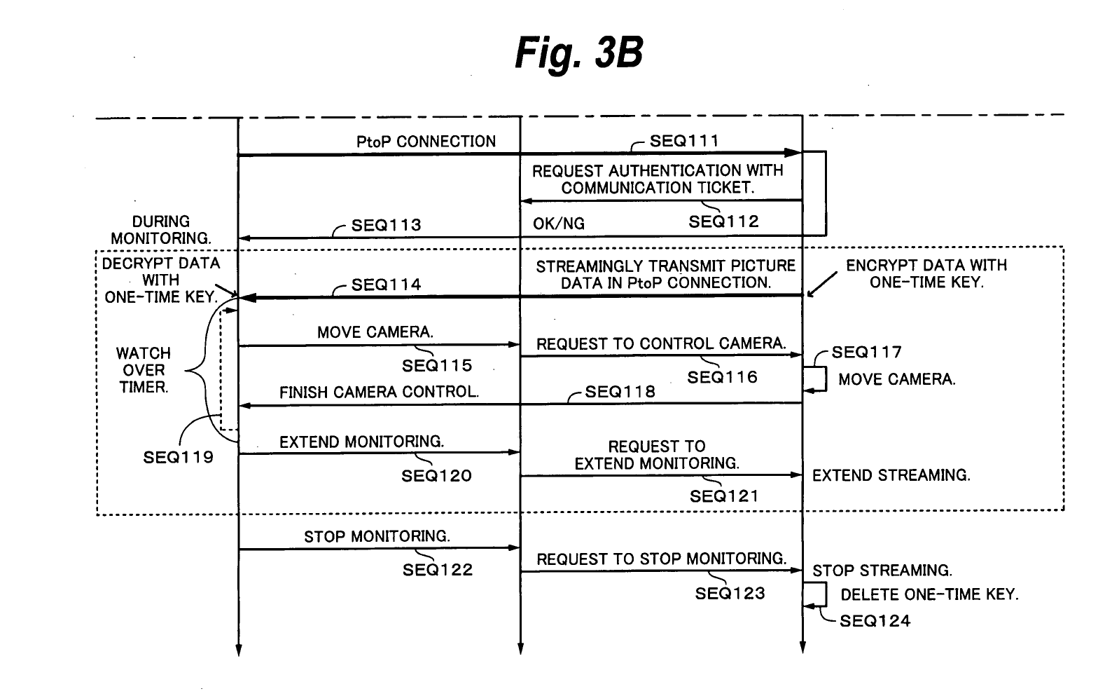

FIG. 3 is a sequence chart showing an example of a procedure for monitoring picture data photographed by the surveillance camera 11. In FIG. 3, “PC” represents an information unit 3 on which the user monitors the interior of the house with a photographed picture. The information unit 3 is for example a personal computer. Next, the information unit 3 will be abbreviated as PC3.

When the user performs a predetermined operation with the PC 3, it is connected to the HS server 2. For example, when the user presses a connect button on a graphical user interface displayed as a monitoring screen that will be described later, the HS server 2 performs an authenticating process for the PC 3 connected thereto (at SEQ 100). The HS server 2 can perform the authenticating process with for example a user ID and a password. The user pre-registers his or her user ID and password to the HS server 2. The HS server 2 requests the information unit 3 to input the user ID and the password on for example a web page. The HS server 2 authenticates the PC 3 by determining whether the input user ID and password match the registered user ID and password.

The authenticating process may be performed with a media access control (MAC) address uniquely assigned to a physical port through which the PC 3 is connected to the network in addition to pre-registered user ID and password.

When the HS server 2 has successfully authenticated the PC 3, the user (PC 3) is logged in the HS server 2. Then, the PC 3 requests the HS server 2 to monitor the interior of the house 1 with the surveillance camera 11 disposed therein (at SEQ101). When a plurality of surveillance cameras 11 are disposed in the house 1, one of them is selected and designated. A request transmitted at SEQ 101 includes information that designates the surveillance camera 11. Then, the HS server 2 receives the request, communicates with the in-house security unit 10 disposed in the house 1, and asks the in-house security unit 10 whether the designated surveillance camera 11 can monitor the interior of the house 1 (at SEQ 102).

As described above, when the sensors 12, 12, and so forth have detected an abnormal situation, since the process against the abnormal situation is prioritized, the user is not allowed to monitor the interior of the house in real time. When the in-house security unit 10 has not been turned on or a person in the house 1 has turned off the security function, the user is not allowed to monitor the interior of the house 1.

When the in-house security unit 10 has been asked to do that, it determines whether the designated surveillance camera 11 can monitor the interior of the house 1 (at SEQ 103). The determined result is transmitted from the in-house security unit 10 to the HS server 2 (at SEQ 104). When the determined result represents that the designated surveillance camera 11 cannot monitor the interior of the house 1 (namely, the determined result is NG), the HS server 2 can inform the PC 3 of that (not shown). In this case, it is more preferred that the HS server 2 should inform the PC 3 of the reason why the designated surveillance camera 11 cannot monitor the interior of the house 1.

In contrast, when the determined result represents that the designated surveillance camera 11 can monitor the interior of the house 1 (namely, the determined result is OK), a monitoring start request is transmitted from the HS server 2 to the in-house security unit 10 (at SEQ 105). When the in-house security unit 10 receives the request, the in-house security unit 10 generates a one-time key with which photographed picture data is encrypted and decrypted (at SEQ 106). The one-time key is composed of for example a random number. The one-time key is valid in one session that the user is logging in the HS server 2. Thus, when the user logs off the HS server 2 or the PC 3 is disconnected from the HS server 2, the one-time key becomes invalid.

The in-house security unit 10 generates the foregoing one-time key and opens a monitoring port (at SEQ 107). At the next SEQ 108, the in-house security unit 10 returns the one-time key generated at SEQ 106 and the port number opened at SEQ 107 to the HS server 2.

When the HS server 2 has received the one-time key and the port number from the in-house security unit 10, the HS server 2 issues a communication ticket to the PC 3 (at SEQ 109). The communication ticket is an ID that is unique to the system and that is generated whenever the monitoring start request is issued. A communication ticket that is generated is composed of the server name of the HS server 2 to which the PC 3 is connected, a random number having a predetermined length, and the current time of the HS server 2. When the generated communication ticket is duplicated with the currently used communication ticket, another communication ticket is generated again with the same algorithm.

At the next SEQ 110, the HS server 2 returns to the PC 3 information with which the in-house security unit 10 accesses to the PC 3. In other words, the foregoing communication ticket, port number, and one-time key are returned from the HS server 2 to the PC 3 (at SEQ 110). The communication ticket and the port number are contained in for example a hyper text markup language (HTML) document and stored in the HS server 2. By accessing the HTML document, the PC 3 obtains the communication ticket and the port number from the HTML document. The one-time key is sent from the HS server 2 to the PC 3. The one-time key may be contained in the foregoing HTML document. An IP address of the in-house security unit 10 is returned from the HS server 2 to the PC 3.

The PC 3 is connected to the in-house security unit 10 in accordance with these information returned from the HS server 2 (at SEQ 111). Then, the PC 3 and the in-house security unit 10 inform their parties of their IP addresses. Since the PC 3 and the in-house security unit 10 designate their party's IP addresses, the PC 3 and the HS server 2 are peer-to-peer (PtoP) connected.

When the PC 3 and the in-house security unit 10 are connected, the in-house security unit 10 requests the HS server 2 to authenticate the in-house security unit 10 with the communication ticket (SEQ 112). Thus, the in-house security unit 10 can determine whether the PC 3 has been successively authenticated by the HS server 2. When the determined result represents that the PC 3 has been successively authenticated by the HS server 2, the in-house security unit 10 will trust the PC 3. The authenticated result with the communication ticket is transmitted from the in-house security unit 10 to the PC 3 (at SEQ 113).

When the PC 3 has been successively authenticated by the in-house security unit 10 (namely, the determined result is OK), the PC 3 allows the user to monitor the interior of the house 1 with picture data photographed by the surveillance camera 11. The in-house security unit 10 encrypts picture data photographed by the surveillance camera 11 with a one-time key. The in-house security unit 10 streamingly transmits the encrypted picture data in the PtoP connection to the PC 3 (at SEQ 114). The photographed picture data is compression-encoded in accordance with for example the moving picture experts group 4 (MPEG4) and transmitted packet by packet in accordance with the real time transfer protocol (RTP). The streamingly transmitted data is not limited to a picture including a still picture, but for example audio data. In addition, the compression-encoding system is not limited to the MPEG4 system.

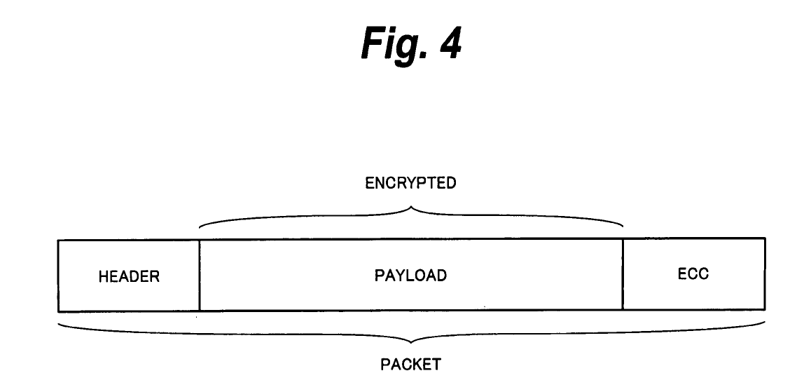

FIG. 4 shows an example of the structure of a packet that contains photographed picture data. A packet is composed of a header portion, a payload portion, and an error correction coding (ECC) portion. Photographed picture data that has been compression-encoded in accordance with the MPEG4 system is stored in the payload portion. The ECC portion contains an error correction code for data contained in the payload portion. Encrypted with a one-time key is data contained in the payload portion. As an example of the encrypting method, the data contained in the payload portion and the one-time key are exclusive-ORed. Of course, the encrypting method is not limited to the method using an exclusive OR operation.

The transmitted stream is received by the PC 3. The payload portion is extracted from the stream. The data contained in the payload portion is decrypted with the one-time key that has been received at SEQ 110. As a result, the original picture data is restored. The restored picture data is reproduced by the PC 3 and displayed as a photographed picture with which the interior of the house 1 is monitored.

With for example a plug-in module of web browser software, photographed picture data can be reproduced and displayed. For example, the HS server 2 is provided with an HTML file that describes the location of photographed picture data as link information. When the PC 3 accesses and reads the HTML file using the web browser software, the photographed picture data is streamingly transmitted from the in-house security unit 10 to the PC 3 in the PtoP connection. In addition, the web browser software determines a plug-in module in accordance with the transmitted stream and activates it.

Since the web browser software and the plug-in module are known technologies, their description will be omitted.

The photographing direction of the surveillance camera 11 can be controlled on the PC 3. When the user presses a button that executes a predetermined function with for example a GUI that is a monitoring screen that will be described later, a command that causes the surveillance camera 11 to change the photographing direction is transmitted from the HS server 2 to the in-house security unit 10. The HS server 2 transmits a camera control request to the in-house security unit 10 in accordance with the command received from the PC 3 (at SEQ 115). The in-house security unit 10 causes the surveillance camera 11 to change the photographing direction of the surveillance camera 11 in accordance with the camera control request (at SEQ 117). After the photographing direction of the surveillance camera 11 has been changed, the in-house security unit 10 informs the PC 3 of that (at SEQ 118). In FIG. 3, a control for causing the photographing direction of the surveillance camera 11 to be changed one time is shown. However, in reality, the control can be repeatedly performed the number of times the user designates (at SEQ 119).

In addition, a monitoring duration can be restricted. With the timer of the web browser software, the monitoring duration is watched. After a predetermined monitoring duration (for example 30 minutes) has elapsed, for example the web browser software causes a predetermined dialog that inquires the user whether to extend the monitoring duration.

When the user has selected the extension of the monitoring, the PC 3 informs the HS server 2 that the monitoring duration is to be extended (at SEQ 120). When the HS server 2 has been informed of that, the HS server 2 transmits a monitoring extension request to the in-house security unit 10 (at SEQ 121). When the in-house security unit 10 has received the extension request, the in-house security unit 10 extends the duration of the streaming transmission of the photographed picture data of the surveillance camera 11 for more 30 minutes for example.

On the other hand, when the user has selected the non-extension of the monitoring duration, the PC 3 informs the HS server 2 that the monitoring is to stop (at SEQ 122). A command that causes the monitoring to stop may be issued by a user's operation on the PC 3. When the user has not responded to the inquiry in a predetermined period, a monitoring stop command may be automatically sent.

When the HS server 2 has received the monitor stop command, the HS server 2 transmits a monitor stop request to the in-house security unit 10 (at SEQ 123). When the in-house security unit 10 has received the monitor stop request, the in-house security unit 10 stops streamingly transmitting the picture data photographed by the surveillance camera 11 and deletes the one-time key (at SEQ 124). The HS server 2 deletes the one-time key by for example initializing an area for the one-time key in the memory 102 or overwriting the data of the one-time key with another data.

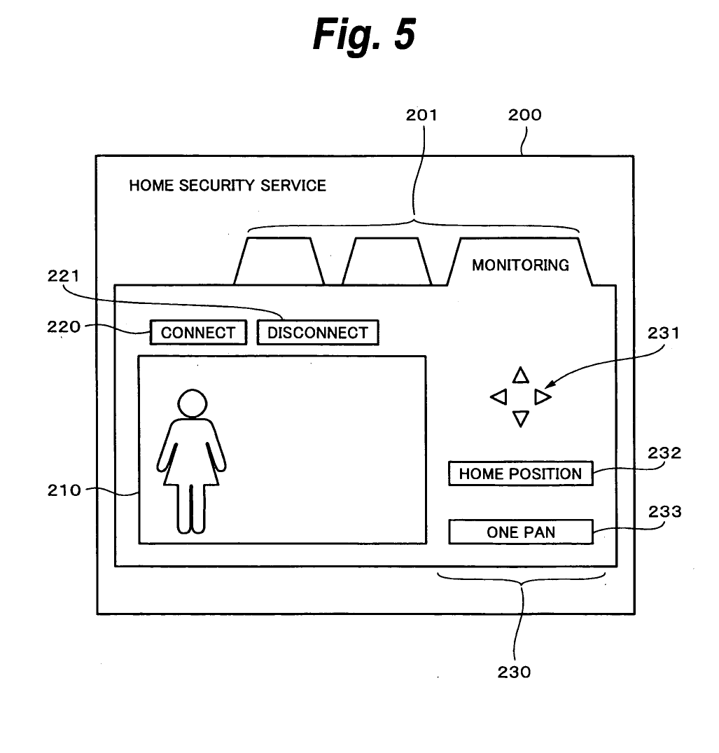

FIG. 5 shows an example of a display screen 200 on the PC 3. The user can monitor the interior of the house 1 with picture data photographed by the surveillance camera 11 on the display screen 200. The web browser software installed on the PC 3 causes the display screen 200 to display data in accordance with the description of for example an HTML file. The display screen 200 composes a graphical user interface (GUI). Buttons and so forth placed on the screen are designated in accordance with coordinate information that is output from a pointing device such as a mouse. When the user operates the mouse or the like for a button displayed on the screen, a function assigned to the button can be executed.

On the display screen 200, the user can perform various settings, real monitoring controls, and so forth. With a tab portion 201, the user can select a function to be executed. In an example shown in FIG. 5, a function for controlling the monitoring has been selected. A picture that has been photographed by the surveillance camera 11 and distributed from the in-house security unit 10 is displayed on a display portion 210 by the plug-in module of the web browser software.

A connect button 220 is a button that causes the PC 3 to connect the in-house security unit 10. When the user presses the connect button 220, the process starts from SEQ 100 shown in FIG. 3. In other words, when the user presses the connect button 220, the authenticating process at SEQ 100 and the next process are automatically performed in the PC 3, the HS server 2, and the in-house security unit 10. As a result, the PC 3 can monitor the interior of the house 1 with a picture photographed by the surveillance camera 11. A disconnect button 221 is a button that causes the PC 3 to disconnect the in-house security unit 10. With the disconnect button 221, the process starts from SEQ 122 shown in FIG. 3. As a result, the monitoring is stopped.

An operating portion 230 has buttons with which the photographing direction of the surveillance camera 11 is controlled. When the user operates buttons 231, 232, and 233 on the operating portion 230, the process from SEQ 115 to SEQ 118 shown in FIG. 3 is performed.

A four-direction button portion 231 is composed of four direction buttons: up, down, left, and right. When the user presses the left and right direction buttons of the four-direction button portion 231, the surveillance camera 11 is panned. When the user presses the up and down direction buttons of the four-direction button portion 231, the surveillance camera 11 is tilted. When the user presses a home position button 232, the photographing direction of the surveillance camera 11 is returned to the home position. When the user presses a one-pan button 233, the surveillance camera 11 is automatically panned and tilted throughout the entire movable range.

In the foregoing description, the present invention was applied to a home security system. However, the present invention is not limited to such an example. In other words, the present invention can be applied to another system that transmits and receives stream data to be encrypted.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

1. A transmitting apparatus for transmitting stream data through a network, comprising:
generating means for generating a key in accordance with a transmission request for stream data that a reception side has made;
key transmitting means for transmitting the generated key to the reception side through an authenticating server; and
stream data encrypting and transmitting means for encrypting the stream data with the key and transmitting the encrypted data to the reception side after the key has been transmitted to the reception side.

2. The transmitting apparatus as set forth in claim 1,
wherein the key is a random number.

3. The transmitting apparatus as set forth in claim 1, further comprising:
means for deleting the key in accordance with a transmission stop request for the stream data that the reception side has made.

4. The transmitting apparatus as set forth in claim 1,
wherein the stream data encrypting and transmitting means is configured to directly designate the address of the reception side.

5. A transmitting method for transmitting stream data through a network, comprising the steps of:
generating a key in accordance with a transmission request for stream data that a reception side has made;
transmitting the generated key to the reception side through an authenticating server; and
encrypting the stream data with the key and transmitting the encrypted data to the reception side after the key has been transmitted to the reception side.

6. A receiving apparatus for receiving stream data transmitted through a network, comprising:
key receiving means for receiving a key generated on a transmission side in accordance with a transmission request for stream data transmitted to the transmission side and transmitted through an authenticating server;
stream data receiving means for receiving the stream data that has been encrypted with the key and that has been transmitted from the transmission side after the key has been received; and
stream data decrypting means for decrypting the received stream data with the key that has been received.

7. The receiving apparatus as set forth in claim 6,
wherein the key is a random number.

8. The receiving apparatus as set forth in claim 6,
wherein the stream data transmitting means is configured to cause the transmission side to directly designate the address of the receiving apparatus.

9. The receiving apparatus as set forth in claim 6, further comprising:
means for transmitting a transmission stop request for the stream data to the transmission side when the stream data has received for a predetermined duration.

10. A receiving means for receiving stream data transmitted through a network, comprising the steps of:
receiving a key generated on a transmission side in accordance with a transmission request for stream data transmitted to the transmission side and transmitted through an authenticating server;
receiving the stream data that has been encrypted with the key and that has been transmitted from the transmission side after the key has been received; and
decrypting the received stream data with the key that has been received.

11. A transmitting and receiving system for transmitting stream data through a network and receiving the transmitting stream data, comprising:
a transmitting apparatus for transmitting stream data;
a receiving apparatus for receiving the stream data from the transmitting apparatus; and
an authenticating server for authenticating the receiving apparatus,
wherein the transmitting apparatus is configured to generate a key in accordance with a transmission request for stream data that the receiving apparatus has made, transmit the generated key to the receiving apparatus through an authenticating server, and encrypt the stream data with the key and transmit the encrypted data to the receiving apparatus after the key has been transmitted to the receiving apparatus, and
wherein the receiving apparatus is configured to decrypt the stream data with the key that has been received from the transmitting apparatus.

12. The transmitting and receiving system as set forth in claim 11,
wherein the key is a random number.

13. The transmitting and receiving system as set forth in claim 11, further comprising:
means for deleting the key in accordance with a transmission stop request for the stream data that the reception apparatus has made.

14. The transmitting and receiving system as set forth in claim 11,
wherein the transmitting apparatus is configured to directly designate the address of the receiving apparatus.

15. The transmitting and receiving system as set forth in claim 11, further comprising:
means for transmitting a transmission stop request for the stream data to the transmitting apparatus when the stream data has received for a predetermined duration.

16. A transmitting and receiving method for transmitting stream data through a network and for receiving the transmitted stream data, comprising the steps of:
transmitting a key generated on a transmission side to a reception side through an authenticating server in advance;
encrypting stream data with the key on the reception side; and
transmitting the encrypted stream data to a reception side; and
decrypting the encrypted stream data with the key on the reception side.

17. A transmitting apparatus for transmitting a still picture through a network, comprising:
generating means for generating a key in accordance with a transmission request that a reception side has made;
key transmitting means for transmitting the generated key to the reception side through an authenticating server; and
still picture encrypting and transmitting means for encrypting the still picture with the key and transmitting the encrypted still picture to the reception side after the key has been transmitted to the reception side.
